(19) United States
(12) Patent Application Publication
(10) Pub. No.: US 2016/0202455 A1
(43) Pub. Date: Jul. 14, 2016

(54) OPTICAL ZOOM LENS WITH TWO LIQUID LENSES

(71) Applicants: OPTOTUNE AG, Dietikon (CH); KNOWLES GMBH, Dietikon (CH)

(72) Inventors: Manuel ASCHWANDEN, Allenwinden (CH); Michael BUEELER, Vogelsang (CH); Martin SALT, Adliswil (CH)

(73) Assignees: Optotune AG, Stans (CH); KNOWLES GMBH, Dietikon (CH)

(21) Appl. No.: 14/912,929

(22) PCT Filed: Aug. 20, 2013
(86) PCT No.: PCT/CH2013/000146

§ 371 Date: Feb. 19, 2016

(51) Int. Cl. G02B 13/00; G02B 27/00; G02B 3/14

(52) U.S. Cl. CPC G02B 13/0075; G02B 3/14; G02B 27/0025; G02B 13/009; G02B 13/0065

(57) ABSTRACT

Optical zoom system (1) for imaging an object plane (100) onto an imaging plane (200), e.g. for a smartphone camera, and comprising two liquid lenses (10, 20) followed by a fixed correction lens (30, 50, 60), the liquids having an Abbe number greater than 60.

### TECHNICAL FIELD

The invention relates to an optical system which provides a zooming and a focusing possibility.

### BACKGROUND ART

Different types of optical zoom lens systems have been proposed, e.g., relying on a parfocal operation principle or relying on a varifocal operation principle.

In a parfocal optical zoom lens system, an afocal subsystem provides various magnification- or zoom-levels (zooming). An additional focusing subsection of the parfocal optical zoom lens system provides various focus positions (focusing). Thus, the focusing is independent from the zooming, i.e., the parfocal optical zoom lens system usually stays in focus when a zoom-level is changed. However, the potential for miniaturization of such parfocal optical zoom lens systems is rather limited which is particularly relevant for space-sensitive applications, e.g., in smartphones or medical endoscopes.

In a varifocal optical zoom lens system, two focusing lenses with a tunable relative position and/or (a) tunable focal length(s) are utilized to enable zooming and focusing. Usually, a varifocal optical zoom lens system has to be refocused when the zoom-level is changed. While varifocal optical zoom lens systems are easier to miniaturize, it is challenging to provide a good optical quality, in particular when tunable lenses (i.e., lenses with a tunable focal length) are used.

WO 2010/103037 A1 discloses an optical zoom lens system with a tunable lens having a membrane separating two optical media. However, the optical quality of such an optical zoom lens system can still be improved.

### DISCLOSURE OF THE INVENTION

Therefore, it is an object of the present invention to provide an improved optical system With a zooming- and a focusing-possibility and better optical quality, which optical system is easier to miniaturize and/or easier to apply in space-sensitive applications.

This object is achieved by the optical systems of the independent claims.

Accordingly, an optical system for imaging an object plane (where, e.g., a to-be-imaged-object such as a person, a building, or a medical structure is arranged) onto an imaging plane (where, e.g., an imaging sensor such as a CCD or a CMOS sensor is arranged) comprises said object plane, said imaging plane, and a first tunable lens which is arranged between said object plane and said imaging plane.

The first tunable lens itself comprises a first fixed (i.e., non-axially movable) container which is made of a rigid material. The term “rigid material” herein relates to a material such as a Polycarbonate or a Cyclo Olefin Polymer with a tensile strength k>2000 MPa which is in particular not or only insignificantly deformable by an optional actuator of the optical system (see below). The first tunable lens furthermore comprises a first deformable membrane which is made of an elastic material. The term “elastic material” herein relates to a material such as an elastomer in particular a silicone or glass with a tensile strength k<5 MPa which is in particular elastically deformable, e.g., by means of the optional actuator of the optical system (see below). Thus, a focal length of the first tunable lens can be changed by deforming the deformable membrane (or regions thereof) of the first tunable lens. Advantageously, only a single deformable membrane is connected to (e.g., sealed to) the container of the first tunable lens which simplifies the construction of the optical system.

Furthermore, the optical system comprises a second tunable lens which is arranged between the first tunable lens and the imaging plane. The second tunable lens itself comprises a second fixed container which is made of a rigid material (see above for examples). The second tunable lens furthermore comprises a second deformable membrane which is made of an elastic material (see above for examples). Thus, also a focal length of the second tunable lens can be changed, e.g., by deforming the second deformable membrane (or regions thereof). As in the first tunable lens, advantageously, only a single membrane is connected to the container of the second tunable lens which simplifies the construction of the optical system.

Because of the possibility to change (or “tune”) the focal lengths of the first tunable lens and of the second tunable lens, a combination of different focal positions (i.e., a focusing possibility) and different zoom-levels (i.e., a zooming possibility) is achieved for the optical system. This enhances the applicability of the optical system.

Furthermore, the optical system comprises at least one fixed correction lens. This correction lens is made of a rigid material (see above for examples) and it is arranged between the second tunable lens and the imaging plane. Various optical aberrations such as spherical aberrations, chromatic aberrations, coma, etc. are corrected by this fixed correction lens. Thus, the optical quality and the imaging properties of the optical system are improved.

In the optical system according to the invention, the first tunable lens further comprises a first fluid which is enclosed by at least the first container and the first membrane (or regions thereof). The second tunable lens further comprises a second fluid which is enclosed by at least the second container and the second membrane (or regions thereof). An Abbe number (which is indicative of the dispersion of an optical material) of each of the first fluid of the first tunable lens and of the second fluid of the second tunable lens is larger than 60, in particular larger than 80. Thus, a lower dispersion is achieved for light that traverses the first and the second fluids. Thus, optical aberrations such as chromatic aberrations of the optical system are less pronounced and/or easier to correct. This leads to a better optical performance of the optical system and thus to an improved imaging quality of the optical system.

As an alternative to such higher-Abbe-number fluids, the first container of the first tunable lens is oriented towards the object plane. The term “oriented towards” herein relates to a configuration in an axial direction. In other words, the first container of the first tunable lens faces the axial direction towards the object plane instead of facing the direction of the imaging plane. Herein, the term “axial” relates to a direction parallel to “optically upstream”, i.e., towards the object plane and “optically downstream”, i.e., towards the imaging plane. In the special case of a straight (e.g., non-folded) optical axis (see below) of the optical system, this straight optical axis defines a straight axial direction of the optical system. When the optical axis is folded, the axial direction is folded as well in the same manner as the optical axis. Usually, in the case of rotationally symmetric lenses of the optical system, the axial direction coincides with an axis of rotational symmetry of these lenses. Furthermore, at least a first region of the first membrane of the first tunable lens is oriented towards the imaging plane. In other words, the first tunable lens comprises a side with the first container and an, e.g., opposing side with the deformable membrane and its first region. Then, the container-side of the tunable lens is oriented towards the object plane while the membrane-side is oriented towards the imaging plane. Thus, optical aberrations of the optical system such as chromatic aberrations are less pronounced and/or easier to correct. This leads to a better optical performance of the optical system and thus to an improved imaging quality of the optical system.

A combination of both approaches, i.e., an optical system with
a first and a second tunable lens fluid with Abbe-numbers larger than 60 each, in particular larger than 80 each, and
an orientation of the first container towards the object plane and an orientation of the first membrane (or its first region) towards the imaging plane

is advantageous because it further reduces optical aberrations and/or makes them easier to correct. This leads to an even better optical performance of the optical system and thus to an improved imaging quality of the optical system.

In an advantageous embodiment, the optical system has an f-number of 3.4 (i.e., in common photography notation, f/3.4=(f/1)/(sqrt(2)^{3.5})) or faster. Thus, more light is transmitted through the optical system which helps to improve imaging quality and enables reduced depth-of-fields which are often used in photography for aesthetic reasons (bokeh).

In another advantageous embodiment, the optical system is structured to image parallel light rays from said object plane to a focal point in said imaging plane, at least for one combination of a focal length of said first tunable lens and a focal length of said second tunable lens. Thus, the optical system can be focused to “infinity” which enhances the applicability of the optical system.

In an advantageous embodiment, the optical system is structured to image diverging light rays from the object plane (e.g., from a point of a to-be-imaged object in the object plane) to a focal point in the imaging plane, at least for one combination of a focal length of said first tunable lens and a focal length of said second tunable lens. The axial distance between the object plane and the first tunable lens can be smaller than 30 mm, in particular smaller than 20 mm. Thus, the optical system can be focused to, e.g., “macro” which enhances the applicability of the optical system. Other distances between the object-plane and the first tunable lens are possible as well.

In an advantageous embodiment, the optical system is structured to provide a continuous plurality of zoom-levels (i.e., a continuously adjustable zoom-level) and a continuous plurality of focus positions (i.e., a continuously adjustable focus). This is achievable by continuously tuning the focal lengths of the first and the second tunable lenses. Thus, not only discrete zoom-levels and/or focus positions can be provided which enhances the applicability of the optical system.

In another advantageous embodiment, the second container of the second tunable lens of the optical system is oriented towards the object plane. At least a second region of the second membrane of the second tunable lens is oriented towards the imaging plane. In other words, a container-side of the second tunable lens is oriented towards the object plane while a membrane-side with the second region of the second tunable lens is oriented towards the imaging plane. This leads to an even better optical performance of the optical system and thus to an improved imaging quality of the optical system.

Each of a or said first region of the first membrane of the first tunable lens and the second region of the second membrane of the second tunable lens are advantageously structured to assume a convex shape and a concave shape. This means that both membrane-regions can assume both a convex and a concave shape. Thus; more combinations of achievable zoom-levels and focus positions are achieved and the applicability of the optical system is enhanced.

In such a case, the first region advantageously assumes (or, in other words, it is in) a convex shape when the second region assumes/is in a concave shape, at least when the optical system is in a first zoom-level such as a tele-zoom-level.

Advantageously, the first region can assume/be in a concave shape when the second region assumes/is in a convex shape, at least when the optical system is in a second zoom-level such as a wide-zoom-level.

In other words, the first membrane and the second membrane advantageously have inverted deflection states. Thus, an improved optical quality of the optical system is achieved and aberrations are reduced, easier to correct, and/or they at least in part compensate each other.

Yet another advantageous embodiment of the optical system further comprises at least one actuator, in particular two actuators, advantageously of the group of
an electrostatic actuator,
an electromagnetic actuator,
an electroactive polymer actuator,
a piezo actuator, and
a fluid pump actuator.

The first tunable lens and/or its first region and the second tunable lens and/or its second region are structured to be deformed by said at least one actuator, in particular by said two actuators. This is done such that a or said focal length of the first tunable lens and a or said focal length of the second tunable lens can be changed by means of the actuator(s). As an example, a first fluid pump actuator and a-second fluid pump actuator can be used to tune the focal lengths of the first and second tunable lenses, respectively. Thus, the focal length of the first tunable lens and/or the focal length of the second tunable lens are easier to change, particularly independently from each other, by means of the actuator(s). Thus, a focusing and a zooming of the optical system can be realized easier. This enhances the possible combinations of achievable zoom-levels and focus positions and thus the applicability of the optical system.

In another advantageous embodiment, the optical system comprises at least 3, in particular at least 4, particularly exactly 4, fixed correction lenses. These correction lenses are made of a rigid material (see above for examples) and are applied to reduce aberrations in the optical system such as chromatic aberrations, spherical aberrations, piston, tilt, coma, astigmatism, etc. Thus, the imaging quality of the optical system is improved. In particular, the fixed correction lenses are arranged between the second tunable lens and the imaging plane which has turned out to improve optical quality even further.

Advantageously, an optical surface, in particular all optical surfaces, of these fixed correction lenses has a minimal best fit absolute radius of curvature value of 2 mm or more. Thus, these correction lenses are easier to produce, e.g., they can be made of a plastic material by injection molding techniques. Furthermore, the correction lenses are easier to align during assembly of the optical system. This reduces production costs and increases the yield.

When the correction lenses are arranged between the second tunable lens and the imaging plane, an optical surface of one of these correction lenses which correction lens is arranged closest to the second tunable lens advantageously has a stronger curvature (i.e., a smaller best fit radius of curvature value) than any other optical surfaces of these correction lenses. In other words, the first correction lens (i.e., the correction lens which is arranged closest to the second tunable lens) acts as primary focusing lens due to its optical surface with a strongest curvature. Thus, the optical quality of the optical system is improved.

In another advantageous embodiment of the invention, at least one fixed correction lens is adapted to correct a field curvature of the optical system. Thus, the optical quality of the optical system is improved, because a curved imaging field in the imaging plane of the optical system is prevented or its curvature is at least reduced.

Yet another advantageous embodiment of the optical system is structured to assume at least a tele-zoom-level configuration and a wide-zoom-level configuration. Then, a maximum chief ray angle at an axial position between the second tunable lens and the imaging plane in the tele-zoom-level configuration does not differ by more than 5° from a maximum chief ray angle at an axial position between the second tunable lens and the imaging plane in said wide-zoom-level configuration. In the case of a continuous plurality of zoom-levels, this is true for all zoom levels. Thus, the fixed correction lens/lenses are easier to optimize and the improved optical correction provided by these fixed correction lenses enhances the imaging performance of the optical system.

In another advantageous embodiment of the optical system, the first container of the first tunable lens is meniscus shaped, i.e., with a convex outside of the first container and with a concave inside of the first container. The first deformable membrane can then follow (with or without a direct contact) the concave inside of the first container when the membrane is in a concave state. Thus, the optical system can be realized in a more space saving way.

Additionally or as an alternative, the second container of the second tunable lens is meniscus shaped with a convex outside and a concave inside, Again, the second deformable membrane can then follow the concave inside of the second container when the second membrane is in a concave state.

Thus, the tunable lenses are easier to realize and the optical system can be produced in a more space-saving way. Furthermore, the optical quality of the optical system is enhanced.

More advantageously, an optical front surface of the first container of the first tunable lens has a convex shape and an optical back surface of the first container of the first tunable lens has a concave shape. Thus, the optical quality of the optical system is improved. In particular, said optical front surface is oriented towards said object plane and said optical back surface is oriented towards said first membrane of said first tunable lens. Thus, the optical quality of the optical system is improved further. The optical back surface is advantageously a substantially spherical surface. Thus, thermally induced degradation of the optical performance of the optical system due to different changes in refractive index of the container and the other parts of the tunable lens (such as fluid) is prevented or at least reduced.

More advantageously, an optical front surface of the second container of the second tunable lens has a convex shape and an optical back surface of the second container of the second tunable lens has a concave shape. Thus, the optical quality of the optical system is improved. In particular, said optical front surface is oriented towards said object plane and said optical back surface is oriented towards said second membrane of said second tunable lens. Thus, the optical quality of the optical system is improved further. The optical back surface is advantageously a substantially spherical surface. Thus, thermally induced degradation of the optical performance of the optical system due to different changes in refractive index of the container and the other parts of the tunable lens (such as fluid) is prevented or at least reduced.

The optical system advantageously comprises an aperture stop, particularly a round aperture stop, which is in particular arranged between the first tunable lens and the second tunable lens. Thus, it is easier to minimize the size of the first and second tunable lens while keeping an achievable f-number low and a relative illumination of the imaging plane high.

As an alternative, the aperture stop can also be arranged axially downstream of the second tunable lens, i.e., between the second tunable lens and the imaging plane, which makes it easier to keep the an f-number of the optical system substantially constant over all zoom-levels.

In another advantageous optical system, the first tunable lens additionally comprises a first fixed (i.e., non axially or laterally movable) lens shaper. Such a fixed lens shaper can, e.g., be realized as a fixed ring which is made of a rigid material (e.g., Silicon, Si) and which ring is in contact with a section of the first deformable membrane. Thus, the first membrane is separated into an optically active section (e.g., in the center of the first membrane) and into an optically passive section (e.g., in the lateral part of the first membrane) by the lens shaper. The optically passive section is in particular connected (e.g., glued or welded) to the lens shaper. Alternatively or in addition, the second tunable lens can also comprise a second fixed lens shaper which can again be realized as a rigid ring which is in contact with a section of the second deformable membrane. Thus, shapes of the deformable membrane(s) or at least of its/their optically active section(s) are easier to control and the optical quality of the optical system is enhanced.

Then, advantageously, an axial distance between the first lens shaper of the first tunable lens and the aperture stop does not differ by more than ±50% and in particular not more than ±20% from an axial distance between the second lens shaper and the aperture stop. Because of this substantially symmetric arrangement of the lens shapers around the aperture stop, the optical quality of the optical system is enhanced because optical aberrations are avoided and/or are easier to correct.

Yet another advantageous optical system further comprises a folding prism for diverting an optical axis of the optical system. In other words, the optical axis is not a straight line but it can be folded, e.g., by 90°. Thus, the optical system can be realized smaller, in particular with a smaller overall length. This enhances the applicability of the optical system, in particular for space sensitive applications such as in medical endoscopes or in smartphones or other camera equipped technical devices.

Advantageously, the folding prism can have a non-quadratic, in particular a rectangular footprint and/or it can comprise a cut edge. Thus, a non-quadratic (e.g., rectangular) sensor can be fully illuminated through the optical system while the optical system can be realized with a smaller overall height. Thus, the optical system is more suited for space-sensitive applications such as in smartphones.

Advantageously, at least a or said first region of the first membrane of the first tunable lens directly faces the folding prism. In other words, no additional optical components such as curved optical components are arranged between the first region of the first membrane and the folding prism. Thus, the optical system can be realized in a space saving way and it is more suited for space-sensitive applications such as in smartphones.

More advantageously, a or said optical front surface of the second container of the second tunable lens (which optical front surface is oriented towards said object plane) directly faces the folding prism. In other words, no additional optical components such as curved optical components are arranged between the optical front surface of the second container and the folding prism. Alternatively, only one or more apertures and/or aperture stops are arranged between the front surface of the second container and the folding prism. Thus, the optical system can be realized in a space saving way and it is more suited for space-sensitive applications such as in smartphones.

In another advantageous optical system comprising an aperture stop and a folding prism, an axial distance between the aperture stop and the folding prism is smaller than or equal to 1.5 times a smallest lateral radius of the aperture stop. Thus, the optical system can be realized in a space saving way and it is more suited for space-sensitive applications such as in smartphones.

In another advantageous embodiment of the optical system, the first tunable lens (in particular a or said first optical surface of the first container of the first tunable lens) directly faces the object plane. In other words, no additional optical components such as curved optical components are arranged between the first tunable lens and the object plane.

Alternatively, a protection element such as a cover glass, in particular only such a protection element (i.e., no additional optical components such as curved optical components), is arranged between the first tunable lens and the object plane.

Thus, the first tunable lens or the protective element acts as a protection cover, e.g., against dust and/or scratches for the optical system, the optical system can be realized more compact, and it is easier to clean.

In an advantageous embodiment of the optical system, a or said first fluid of the first tunable lens comprises a liquid, in particular it consists of a liquid. Alternatively or in addition, a or said second fluid of the second tunable lens comprises a liquid, in particular it consists of a liquid. Thus, the tunable lens(es) can be realized in a simpler and optically advantageous way and more complicated fluid lenses relying on more than one liquid with different indices of refraction and a fluid interface are not necessary. This makes the realization of the optical system simpler and enhances the optical quality of the optical system.

In yet another advantageous embodiment of the optical system, a or said optical front surface of said first container of said first tunable lens (which surface is advantageously oriented towards said object plane) is a non-spherical surface. Thus, the optical quality of the optical system is enhanced, in particular for wider zoom-levels of the optical system.

In another advantageous optical system, a or said second region of said second membrane of said second tunable lens is structured to be symmetrically deflectable around a zero position. As an example, in a tele-zoom-level of the optical system, the second region of the second membrane is in a concave shape whereas for a wide-zoom-level of the optical system, the second region of the second membrane is in a convex shape. Then, the concave shape and the convex shape are substantially symmetrical around the zero position, i.e., around an un-displaced second membrane position. Thus, an imaging quality of the optical system is improved because optical aberrations are less pronounced and/or easier to correct.

Yet another advantageous embodiment of the invention comprises an inner barrel in which the first tunable lens, the second tunable lens, and the fixed correction lens are arranged. Furthermore, the optical system additionally comprises an outer barrel in Which at least parts of at least one actuator for changing a focal length of said first tunable lens and/or a focal length of said second tunable lens are arranged. Thus, the actuator can at least in part be mechanically decoupled from the optical components of the optical system which helps to improve the optical quality of the optical system.

Advantageously, an Abbe number of said at least one fixed correction lens is larger than 50, in particular larger than 55. This enhances the optical quality of the optical system even further.

As another aspect of the invention, a method for operating an optical system as described above comprises steps of
providing an optical system as described above for imaging an object plane to an imaging plane,
tuning a focal length of a first tunable lens of said optical system, and/or
tuning a focal length of a second tunable lens of said optical system,

wherein at least a first region of a first membrane of said first tunable lens assumes a convex shape when a second region of a second membrane of said second tunable lens assumes a concave shape, and/or

wherein at least a first region of a first membrane of said first tunable lens assumes a concave shape when a second region of a second membrane of said second tunable lens assumes a convex shape.

Thus, the optical quality of the optical system is improved.

As yet another aspect of the invention, a cellular phone or a tablet computer comprises
an optical system as described above, and
an imaging sensor arranged in an imaging plane of said optical system. Thus, an imaging quality of the cellular phone or tablet computer is significantly improved while space is saved.

Remarks:

The described embodiments similarly pertain to the devices and the method. Synergetic effects may arise from different combinations of the embodiments although they might not be described in detail.

### BRIEF DESCRIPTION OF THE DRAWINGS

Embodiments of the invention are described in the following detailed description. Such description makes reference to the annexed drawings, wherein:

FIG. 1 shows an optical system 1 according to a first embodiment of the invention, wherein the optical system 1 is in a tele-zoom configuration,

FIG. 2 shows the optical system 1 of FIG. 1, wherein the optical system 1 is in a wide-zoom configuration,

FIG. 3 shows the optical system 1 of FIGS. 1 and 2, wherein a folded optical axis A as well as a cut edge 81 of a folding prism 80 is shown,

FIG. 4 shows an optical system 1 according to a second embodiment of the invention, the optical system 1 comprising three fixed correction lenses 30, 50, and 60, and an optional cover glass 300,

FIG. 5 shows a cellular phone 999 comprising an optical system 1 and an imaging sensor (202), and

FIG. 6 shows a table of properties of the components of the optical system 1 according to the second embodiment of FIG. 4.

### DETAILED DESCRIPTION OF THE DRAWINGS

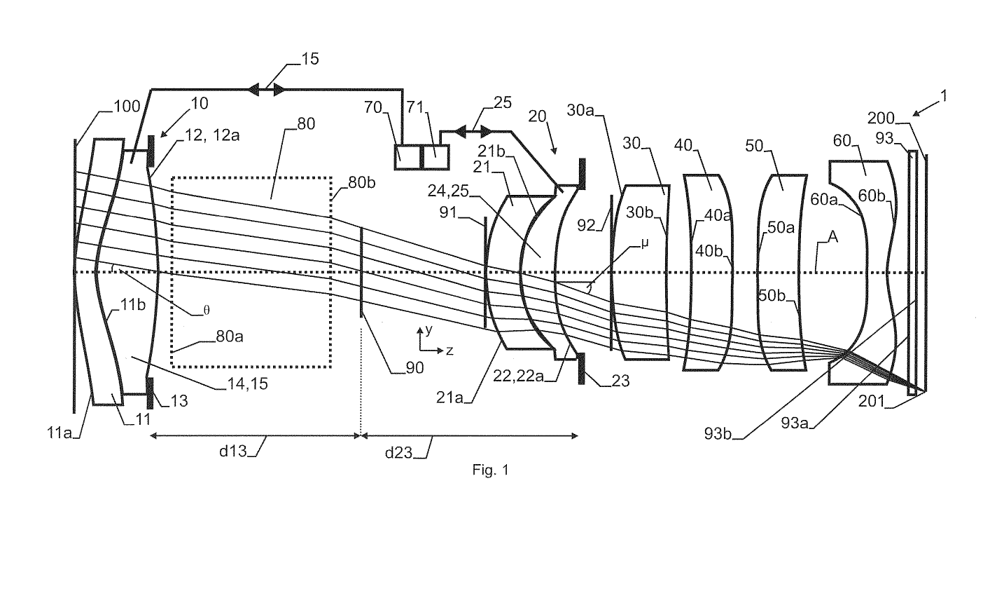

FIG. 1 shows an optical system 1 according to a first embodiment of the invention. The optical system 1 comprises an object plane 100, where a to-be-imaged object is arranged (not shown). Specifically here, the optical system 1 is focused to “infinity”, i.e., parallel light rays from the object plane 100 are imaged to a focal point 201 in an imaging plane 200, where they are digitized by a CMOS sensor (not shown). Only 6 such light rays from an optical simulation are schematically shown for clarity. In FIG. 1, the optical system 1 is in a tele-zoom configuration, i.e., with a maximum angle between incoming light rays and an optical axis A of the optical system of θ=12 degrees.

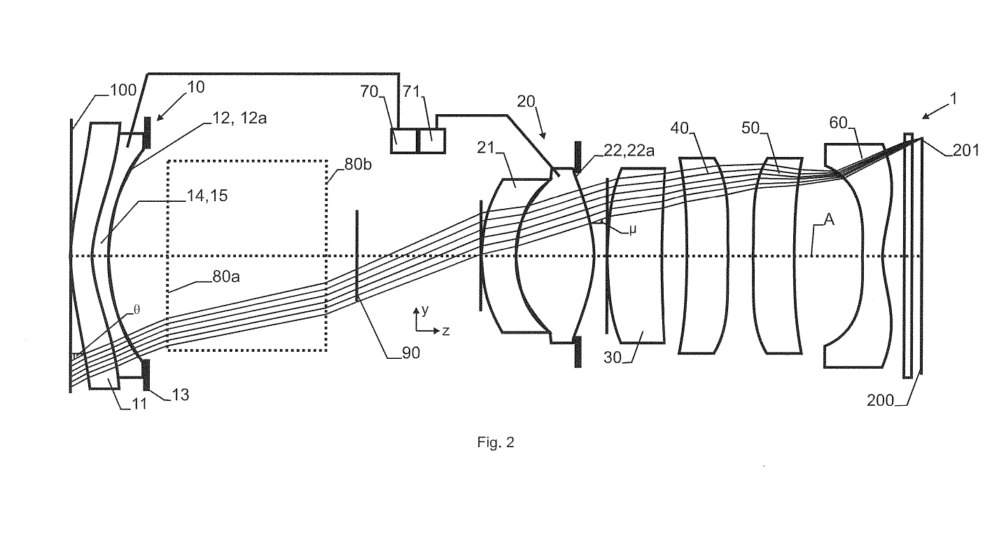

The light rays then pass a first tunable lens 10 comprising a first fixed container 11 and a first deformable membrane 12. A convex optical front surface 11a of the first container 11 directly facing the object plane 100 is a non-spherical surface, but its slope decreases with an increasing radius. This creates more optical power for inclined outer fields (also see below with regard to FIG. 2). An optical back surface 11b of the first container 11 facing the first membrane 12 has a concave and substantially spherical shape. This makes the first container meniscus shaped.

A first fixed ring-shaped Silicon lens shaper 13 separates the first membrane 12 into a central optically active section 12a and an annular-shaped optically passive section. The optically active section 12a is comprised in a first region 12a of the membrane 12 which is suitable for low-loss light transmission, e.g., using an anti-reflex coating (not shown). In this case, the first region 12a and the optically active section 12a coincide.

Due to the lens shaper 13, the shape of the optically active section 12a is easier to control. The first fixed container 11 is made of Zeonex which is a rigid material which is not deformed by a first actuator 70 (a fluid pump actuator in the first embodiment).

The elastic membrane 12 is made of silicone and its shape and thus the focal length f1 of the first tunable lens 10 can be influenced by a pressure of a single liquid 15 in a first chamber 14. This first chamber 14 is enclosed by the first container 11 and the first membrane 12 of the first tunable lens 10. For continuously adjusting a focal length of the first tunable lens 10, the first actuator 70 is structured to regulate the fluid pressure inside the first chamber 14 and thus to influence a radius of curvature of the optically active section 12a of the first membrane 12. In the tele-zoom configuration which is shown in FIG. 1, the shape of the first membrane 12 (and of its optically active section/first region 12a) assumes a convex shape such that the first tunable lens 10 assumes a biconvex shape. The first container 11 of the first tunable lens 10 is oriented towards the object plane 100 and the membrane 12 of the first tunable lens 10 is oriented towards the imaging plane 200 of the optical system 1. Thus, optical aberrations are easier to correct and the optical quality of the optical system 1 is enhanced. An Abbe number of the first fluid 15 is 94 such that chromatic aberrations are less pronounced and easier to correct.

After the first tunable lens 10, the light travels axially downstream along the optical axis A (which is in this case parallel to the z-direction) of the optical system 1 and passes a round aperture stop 90 and a vignetting aperture 91 which are arranged between the first tunable lens 10 and a second tunable lens 20 of the optical system 1. The passthrough regions of the aperture stop 90 (1.09 mm radius) and the vignetting aperture 91 (1.35 mm radius) are shown as black lines in FIG. 1.

The second tunable lens 20 comprises a second fixed container 21 oriented towards the object plane 100, a second deformable membrane 22 oriented towards the imaging plane 200, and a second fixed ring-shaped Si lens shaper 23. The second container 21 of the second tunable lens 20 is also meniscus shaped with a convex optical front surface 21a oriented towards the object plane 100 and a concave, substantially spherical optical back surface 21b oriented towards the second membrane 22. A second actuator 71 (as with the first tunable lens 10, the second actuator 71 for the second tunable lens 20 is also a fluid pump actuator) is used to continuously adjust a focal length f2 of the second tunable lens 20 by pumping a liquid 25 in and out of a second chamber 24. Specifically here, the second membrane 22 (and its optically active section 22a as defined by the second lens shaper 23) assumes a concave shape. Similar to the first tunable lens 10, the optically active section 22a of the second tunable lens 20 is comprised in a second region 22a of the membrane 22 which is suitable for low-loss light transmission, e.g., using an anti-reflex coating; the second region 22a and the optically active section 22a coincide.

An Abbe number of the second fluid 25 is 94 such that chromatic aberrations are less pronounced and easier to correct.

A distance d13 between the first lens shaper 13 and the aperture stop 90 does not differ by more than 20% from a distance d23 between the second lens shaper 23 and the aperture stop 90. Due to this arrangement, optical aberrations are reduced.

The light then passes a second vignetting aperture 92 (radius 1.82 mm) and four fixed correction lenses 30, 40, 50, and 60. These fixed correction lenses 30, 40, 50, 60 are made of a rigid material such as COC or polycarbonate and are structured to correct optical aberrations of the optical system 1. The correction lenses comprise optical front surfaces 30a, 40a, 50a, and 60a arranged optically upstream of respective optical back surfaces 30b, 40b, 50b, and 60b. The fixed correction lens 60 corrects a field of curvature in the imaging plane 200. This enhances the imaging quality of the optical system 1. The first surface/optical front surface 30a of the correction lens 30 has the strongest curvature of all optical surfaces of all correction lenses. Thus, the correction lens 30 acts as a primary focusing lens which improves the optical quality of the optical system 1. None of the optical surfaces have a best fit absolute radius of curvature value below 2 mm which makes the corrective lenses easier to produce and/or align.

The described optical system 1 has an f-number of 3.4 and thus allows a transmission of a larger amount of light which enhances a signal-to-noise ratio of a digitized image, in particular in low-light situations.

By being able to continuously adjust the focal lengths of the first and second tunable lenses 10, 20 as described above, continuous pluralities of zoom-levels and focus positions are achievable for the optical system 1. This enhances the applicability of the optical system 1 because not only discrete steps for focus and/or zoom are possible.

An infrared blocking filter 93 with an optical front surface 93a and an optical back surface 93b is arranged between the correction lens 60 and the imaging plane 200. The filter 93 is used to block unwanted infrared light which might decrease imaging quality of the optical system 1.

It should be noted that the vignetting apertures 91 and 92 can also have square or rectangular shape (not shown).

FIG. 2 shows the optical system 1 of FIG. 1, wherein the optical system 1 is in a wide-zoom configuration, i.e., with a maximum angle between incoming light rays and an optical axis A of the optical system of θ=30 degrees. It is obvious from FIG. 2 that in this configuration the first membrane 12 of the first tunable lens 10 assumes a concave shape whereas the second membrane 22 of the second tunable lens 20 assumes a convex shape. Thus, the membranes 12, 22 have inverted deflection states.

A maximum chief ray angle μ=25.8 degrees at an axial position between the second tunable lens 20 and the imaging plane 200 in the tele-zoom-configuration of FIG. 1 does not differ by more than 1.5° from a maximum chief ray angle μ=24.3 degrees at an axial position between the second tunable lens 20 and the imaging plane 200 in the wide-zoom-configuration of FIG. 2. Thus, the fixed correction lenses are easier to optimize for both, the tele- and the wide-zoom-levels (and all continuous intermediate zoom-levels) of the optical system 1. This enhances the optical quality of the optical system 1.

The position of a folding prism 80 of the optical system 1 with optical front surface 80a and optical back surface 80b is indicated in dotted lines in FIGS. 1 and 2. This folding prism 80 has a rectangular footprint in the y-z-plane for facilitating the use of a fully illuminated rectangular sensor in the imaging plane 200 while keeping its size smaller. For clarity, however, the optical system 1 is shown in a linear configuration in FIGS. 1 and 2.

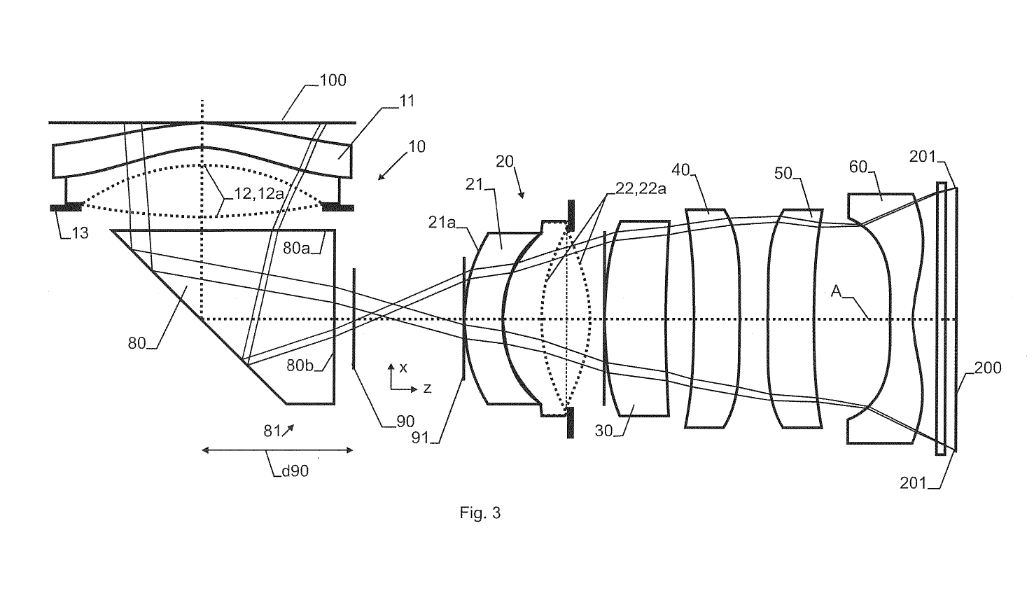

FIG. 3 shows the optical system 1 of FIGS. 1 and 2 from an x-z-view, in which the folding of the optical axis A by means of the folding prism 80 as well as its cut edge 81 are obvious. For clarity, only 2 light rays from FIGS. 1 and 2 (for the tele- and the wide-zoom-configurations) are shown each. The convex and concave shapes of the first and second membranes 12, 22 are shown in dotted lines in FIG. 3. The optical system 1 can be realized in a space-saving way because
the optically active section/first region 12a of the first membrane 12 of the first tunable lens 10 directly faces the folding prism 80,
the optical front surface 21a of the second container 21 of the second tunable lens 20 directly faces the folding prism 80 (with only the aperture stop 90 and the vignetting aperture 91 being arranged between them, i.e., no curved optical components), and
an axial distance d90 between the aperture stop 90 and the folding prism 80 is smaller than or equal to 1.5 times a smallest lateral radius of the aperture stop 90.

This makes the optical system 1 more suited for space-sensitive applications such as in cellular phones.

Furthermore, it is noted that the optically active section/second region 22a of the second membrane 22 of the second tunable lens 20 is substantially symmetrically deflected around a zero position (dashed) in the tele-zoom-level and in the wide-zoom-level configuration. Thus, lens deflections are minimized and optical aberrations are not so pronounced and/or they are easier to correct.

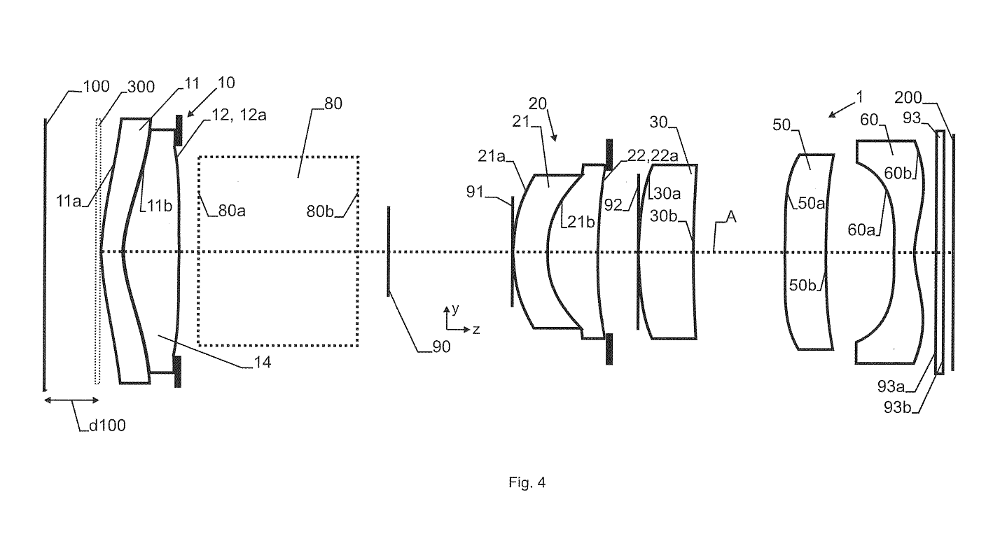

FIG. 4 shows an optical system 1 according to a second embodiment of the invention. The optical system is very similar to the first embodiment of the invention shown in FIGS. 1 to 3 with the exception that only three fixed correction lenses 30, 50, and 60 are arranged between the second tunable lens 20 and the imaging plane 200. Thus, the optical system 1 can be realized in a less complicated way. Furthermore, an optional cover glass 300 is arranged between the object plane 100 and the container 11 of the first tunable lens 10 for protection the optical system 1 against dust and scratches.

In addition, a distance d100 between the object plane 100 and the first tunable lens 10 is smaller than 20 mm. Thus, a macro-photography mode is enabled. Accordingly, the optical system 1 (i.e., a focal length f1 of the first tunable lens 10 and a focal length f2 of the second tunable lens 20) is structured to image diverging light rays from the object plane 100 to a focal point in the imaging plane 200. This enhances the applicability of the optical system 1.

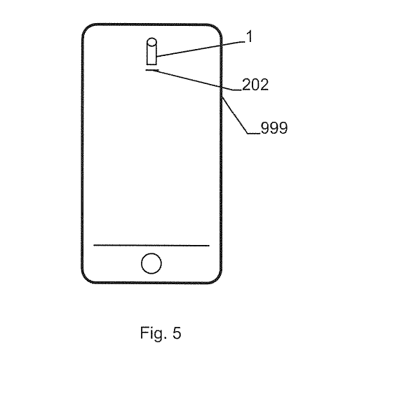

FIG. 5 shows a cellular phone 999 comprising an optical system 1 as described above and an imaging sensor 202 arranged in the imaging plane 200 of the optical system 1. By using an optical system 1, the imaging quality of the camera-equipped cellular phone 999 (smartphone) can be considerably improved.

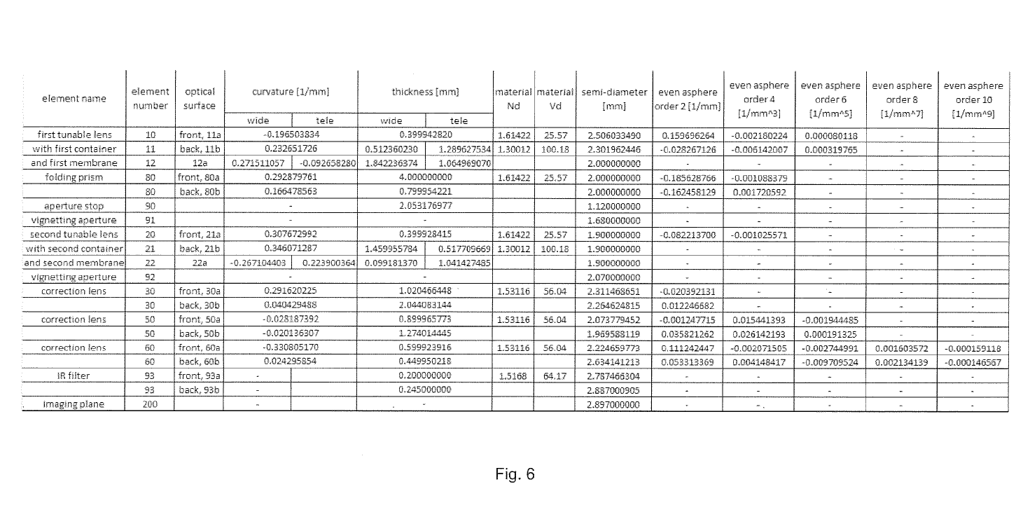

FIG. 6 shows a table of properties (element name, element number, optical surface, curvature, thickness, material refractive index Nd, material Abbe number Vd, semi-diameter, even asphere orders 2, 4, 6, 8, and 10) of the components 10, 80, 90, 91, 20, 92, 30, 50, 60, and 93 of the optical system 1 according to the second embodiment of FIG. 4. Here, a standard notation of optical design software is used in which the material properties are give for a “start surface” and are valid up to (but not including) the subsequent optical surface optically downstream.

While there are shown and described presently preferred embodiments of the invention, it is to be distinctly understood that the invention is not limited thereto but may be otherwise variously embodied and practiced within the scope of the following claims.

1. An optical system (1) for imaging an object plane (100) to an imaging plane (200), the optical system comprising
said object plane (100),
said imaging plane (200),
a first tunable lens (10) arranged between said object plane (100) and said imaging plane (200), said first tunable lens (10) comprising
a first fixed container (11) made of a rigid material,
a first deformable membrane (12) made of an elastic material, and
a first fluid (15) enclosed by at least said first container (11) and said first membrane (12),
a second tunable lens (20) arranged between said first tunable lens (10) and said imaging plane (200), said second tunable lens (20) comprising
a second fixed container (21) made of a rigid material,
a second deformable membrane (22) made of an elastic material, and
a second fluid (25) enclosed by at least said second container (21) and said second membrane (22),
at least one fixed correction lens (30,40, 50,60) made of a rigid material and arranged between said second tunable lens (20) and said imaging plane (200),
wherein an Abbe number of each of said first fluid (15) and of said second fluid (25) is larger than 60, in particular larger than 80.

2. An optical system (1) for imaging an object plane (100) to an imaging plane (200), the optical system comprising
said object plane (100),
said imaging plane (200),
a first tunable lens (10) arranged between said object plane (100) and said imaging plane (200), said first tunable lens (10) comprising
a first fixed container (11) made of a rigid material, and
a first deformable membrane (12) made of an elastic material, and
a second tunable lens (20) arranged between said first tunable lens (10) and said imaging plane (200), said second tunable lens (20) comprising
a second fixed container (21) made of a rigid material, and
a second deformable membrane (22) made of an elastic material,
at least one fixed correction lens (30,40, 50,60) made of a rigid material and arranged between said second tunable lens (20) and said imaging plane (200),
wherein said first container (11) of said first tunable lens (10) is oriented towards said object plane (100), and
wherein at least a first region (12a) of said first membrane (12) of said first tunable lens (10) is oriented towards said imaging plane (200).

3. The optical system (1) of claim 2
wherein said first tunable lens (10) comprises a first fluid (15) enclosed by at least said first container (11) and said first membrane (12),
wherein said second tunable lens (20) comprises a second fluid (25) enclosed by at least said second container (21) and said second membrane (22), and
wherein an Abbe number of each of said first fluid (15) and of said second fluid (25) is larger than 60, in particular larger than 80.

4. The optical system (1) of claim 1, wherein at least for one combination of a focal length (f1) of said first tunable lens (10) and a focal length (f2) of said second tunable lens (20), said optical system (1) is structured to image parallel light rays from said object plane (100) to a focal point (201) in said imaging plane (200).

5. The optical system (1) of any of claim 1, wherein a distance between said object plane (100) and said first tunable lens (10) is smaller than 30 mm, in particular smaller than 20 mm, and
wherein at least for one combination of a focal length (f1) of said first tunable lens (10) and a focal length (f2) of said second tunable lens (20), said optical system (1) is structured to image diverging light rays from said object plane (100) to a focal point (201) in said imaging plane (200).

6. The optical system (1) of claim 1, wherein said optical system (1) is structured to provide a continuous plurality of zoom levels and a continuous plurality of focus positions.

7. The optical system (1) of claim 1,
wherein said second membrane (22) of said second tunable lens (20) comprises a second region (22a) oriented towards said imaging plane (200),
wherein said second container (21) of said second tunable lens (20) is oriented towards said object plane (100), and
in particular wherein said first membrane (12) of said first tunable lens (10) comprises a or said first region (12a), and
wherein said first region (12a) of said first membrane (12) of said first tunable lens (10) and said second region (22a) of said second membrane (22) of said second tunable lens (20) are structured to assume a convex shape and a concave shape.

8. The optical system (1) of claim 7 wherein, at least in a first zoom-level of said optical system (1), said first region (12a) assumes a convex shape and said second region (22a) assumes a concave shape.

9. The optical system of claim 7, wherein, at least in a second zoom-level of said optical system (1), said first region (12a) assumes a concave shape and said second region (22a) assumes a convex shape.

10. The optical system (1) of claim 1, further comprising at least one actuator (70), in particular two actuators (70, 71), particularly of the group of
an electrostatic actuator,
an electromagnetic actuator,
an electroactive polymer actuator
a piezo actuator, and
a fluid pump actuator,
wherein at least a or said first region (12a) of said first membrane (12) of said first tunable lens (10) and at least a or said second region (22a) of said second membrane (22) of said second tunable lens (20) are structured to be deformed by said at least one actuator (70) such that a or said focal length (f1) of said first tunable lens (10) and a or said focal length (f2) of said second tunable lens (20) are changeable by means of said actuator (70).

11. The optical system (1) of claim 1, wherein said optical system (1) comprises at least 3, in particular at least 4, particularly exactly 4, fixed correction lenses (30,40,50,60) made of a rigid material, and in particular wherein said fixed correction lenses (30,40,50,60) are arranged between said second tunable lens (20) and said imaging plane (200).

12. The optical system (1) of claim 11, wherein an optical surface, in particular all optical surfaces, of said fixed correction lenses (30,40,50,60) has a minimal absolute radius of curvature value of 2 mm or more.

13. The optical system (1) of claim 11, wherein said correction lenses (30,40, 50,60) are arranged between said second tunable lens (20) and said imaging plane (200), and
wherein an optical surface (30a) of a correction lens (30) which is arranged closest to said second tunable lens (20) has a smaller best fit radius of curvature value than any other optical surfaces of said correction lenses (30,40,50,60).

14. The optical system (1) of claim 1, wherein at least one fixed correction lens (60) is adapted to correct a field curvature of said optical system (1).

15. The optical system (1) of claim 1, wherein said optical system (1) is structured to assume at least a tele-zoom-level configuration and a wide-zoom-level configuration, and
wherein a maximum chief ray angle at an axial position between said second tunable lens (20) and said imaging plane (200) in said tele-zoom-level configuration is equal to a maximum chief ray angle at an axial position between said second tunable lens (20) and said imaging plane (200) in said wide-zoom-level configuration within a range of ±2.5°.

16. The optical system (1) of claim 1, wherein said first container (11) of said first tunable lens (10) is meniscus shaped and/or wherein said second container (21) of said second tunable lens (22) is meniscus shaped.

17. The optical system (1) of claim 1, wherein an optical front surface (11a) of said first container (11) of said first tunable lens (10) has a convex shape and
wherein an optical back surface (11b) of said first container (11) of said first tunable lens (10) has a concave shape, and
in particular wherein said optical front surface (11a) is oriented towards said object plane (100) and wherein said optical back surface (11b) is oriented towards said first membrane (12) of said first tunable lens (10).

18. The optical system (1) of claim 1, wherein an optical front surface (21a) of said second container (21) of said second tunable lens (20) has a convex shape and
wherein an optical back surface (21b) of said second container (21) of said second tunable lens (20) has a concave shape, and
in particular wherein said optical front surface (21a) is oriented towards said object plane (100) and said optical back surface (21b) is oriented towards said second membrane (22) of said second tunable lens (20).

19. The optical system (1) of claim 1, further comprising an aperture stop (90), in particular a round aperture stop (90), wherein said aperture stop (90) is particularly arranged between said first tunable lens (10) and said second tunable lens (20).

20. The optical system (1) of claim 1,
wherein said first tunable lens (10) additionally comprises a first fixed lens shaper (13) and/or
wherein said second tunable lens (20) additionally comprises a second fixed lens shaper (23).

21. The optical system (1) of claim 19 wherein an axial distance between said first lens shaper (13) and said aperture stop (90) is equal to an axial distance between said second lens shaper (23) and said aperture stop (90) within a range of ±50%, in particular ±20%.

22. The optical system (1) of claim 1, further comprising
a folding prism (80) for diverting an optical axis (A) of said optical system (1).

23. The optical system (1) of claim 22, wherein said folding prism (80) has a non-quadratic, in particular a rectangular, footprint.

24. The optical system of claim 22, wherein said folding prism (80) comprises a cut edge (81).

25. The optical system (1) of claim 22, wherein at least a or said first region (12a) of said first membrane (12) of said first tunable lens (10) directly faces said folding prism (80).

26. The optical system (1) of claim 22, wherein a or said optical front surface (21a) of said second container (21) of said second tunable lens (20), said optical front surface (21a) being oriented towards said object plane (100), directly faces said folding prism (80) or wherein only one or more apertures and/or aperture stops (90) are arranged between said second container (21) and said folding prism (80).

27. The optical system (1) of claim 19, wherein an axial distance between said aperture stop (90) and said folding prism (80) is smaller than or equal to 1.5 times a smallest lateral radius of said aperture stop (90).

28. The optical system (1) of claim 1, wherein said first tunable lens (10) directly faces said object plane (100) or
wherein a protection element (300), in particular only a protection element (300), particularly a cover glass (300), is arranged between said first tunable lens (10) and said object plane (100).

29. The optical system (1) of claim 1, wherein a or said first fluid (15) of said first tunable lens (10) comprises a liquid, in particular consists of a liquid and/or
wherein a or said second fluid (25) of said second tunable lens (20) comprises a liquid, in particular consists of a liquid.

30. The optical system (1) of claim 1, wherein a or said optical front surface (11a) of said first container (11) of said first tunable lens (10) is non-spherical.

31. The optical system (1) of claim 1, wherein a or said optical back surface (11b) of said first container (11) of said first tunable lens (10), said optical back surface (11b) being oriented towards said first membrane (12) of said first tunable lens (10), is substantially spherical and/or
wherein a or said optical back surface (21b) of said second container (21) of said second tunable lens (20), said optical back surface (21b) being oriented towards said second membrane (22) of said second tunable lens (20), is substantially spherical.

32. The optical system (1) of claim 1, wherein a or said second region (22a) of said second membrane (22) of said second tunable lens (20) is structured to be symmetrically deflectable around a zero position.

33. A cellular phone (999) or a tablet computer comprising
an optical system (1) of claim 1, and
an imaging sensor (202) arranged in an imaging plane (200) of said optical system (1).
